(19) United States
(12) Patent Application Publication
(10) Pub. No.: US 2026/0213280 A1
(43) Pub. Date: Jul. 23, 2026

(54) ELECTRICITY STORAGE DEVICE

(71) Applicant: Prime Planet Energy & Solutions, Inc., Tokyo (JP)

(72) Inventor: Shota YANASE, Kobe-shi (JP)

(21) Appl. No.: 19/452,398

(22) Filed: Jan. 19, 2026

(30) Foreign Application Priority Data
Jan. 22, 2025 (JP) 2025-009334

(51) Int. Cl. H01M 10/0587; H01M 10/0525; H01M 50/533; H01M 50/538

(52) U.S. Cl. CPC H01M 10/0587; H01M 50/533; H01M 50/538; H01M 10/0525

(57) ABSTRACT

The electricity storage device includes an electrode assembly, an electrolytic solution, a case, and a first current collector member. The electrode assembly contains a first electrode tab group protruding from a first end face. The electrolytic solution contains an excess electrolytic solution that is present between the electrode assembly and the case. When a height of the first end face of the electrode assembly is treated as H, a length of the first electrode tab group in a height direction is ⅕ H or more and less than ½ H. In a state where SOC is 95% or more, a height of a liquid surface of the excess electrolytic solution is 1/100 H or more and not more than 1/10 H, and a distance between the liquid surface of the excess electrolytic solution and a lower end of a first electrode tab group is equal to or more than ½ H.

### CROSS REFERENCE TO RELATED APPLICATIONS

This application claims the benefit of priority to Japanese Patent Application No. 2025-009334 filed on Jan. 22, 2025. The entire contents of this application are hereby incorporated herein by reference.

### BACKGROUND OF THE DISCLOSURE

A present disclosure relates to an electricity storage device.

JP2024-109343A discloses a technique in which, for making a lithium salt be hardly precipitated at a vicinity of an electrode tab group, at least a part of the electrode tab group is made to come into contact with an electrolytic solution (an excess electrolytic solution) that exists at an outside of an electrode assembly. JP2015-153727A discloses a technique in which, for suppressing temperature unevenness in a height direction of the electrode assembly, a height of the excess electrolytic solution is adjusted to be within a predetermined range.

### SUMMARY

Regarding the electricity storage device that includes the electrode assembly formed in a wide shape, there is a situation where it is difficult, for the electrolytic solution being pushed out to an outside of the electrode assembly at a time of a rapid electrical charge and discharge, to come back to an inside of the electrode assembly. Accordingly, a salt concentration of the electrolytic solution at the inside of the electrode assembly becomes non-uniform, and thus a deterioration of the electricity storage device might be accelerated if an operation under the rapid electrical charge and discharge condition is continued. By a study of the present inventor, it was found that one of reasons why the electrolytic solution hardly came back to the inside of the electrode assembly was a heat expansion of the electrolytic solution caused by a temperature rise of the electrolytic solution. The present inventor is developing the electricity storage device that includes the electrode assembly provided with an electrode tab on a side surface not on an upper part of the electrode assembly. The present inventor considers providing a electricity storage device which may suppress a heat expansion of a electrolytic solution.

One aspect of the present technique is an electricity storage device including an electrode assembly that includes a first electrode and a second electrode, including an electrolytic solution, including a case that is configured to accommodate the electrode assembly and the electrolytic solution, and including a first current collector member that is electrically connected to the first electrode. The case includes a bottom wall, a pair of side walls that are configured to extend from an edge of the bottom wall and to be opposed to each other in a width direction, and an upper wall that is configured to be opposed to the bottom wall in a height direction. The electrode assembly includes a first electrode tab group including plural first electrode tabs being configured to protrude from a first end face at one side in the width direction, and includes a second electrode tab group including plural second electrode tabs being configured to protrude from a second end face at the other side in the width direction. The first current collector member is joined to the first electrode tab group via a first joining part. A length of the electrode assembly in the width direction is equal to or more than two times as long as a length of the electrode assembly in the height direction. The electrolytic solution includes an excess electrolytic solution that is present between the electrode assembly and the case. When a length of the first end face of the electrode assembly in the height direction is treated as H, a length of the first electrode tab group in the height direction is equal to or more than ⅕ H and less than ½ H. In a state where the bottom wall is arranged in a vertically downward direction and a SOC (state of charge) is equal to or more than 95%, a height of the excess electrolytic solution from the bottom wall to a liquid surface is equal to or more than 1/100 H and not more than 1/10 H and a distance between the liquid surface of the excess electrolytic solution and a lower end of the first electrode tab group is equal to or more than ½ H.

The electricity storage device having the configuration described above may suppress the heat expansion of the electrolytic solution because it is difficult to transmit the heat generated at the first electrode tab group to the excess electrolytic solution.

### BRIEF DESCRIPTION OF THE DRAWINGS

FIG. 1 is a perspective view of an electricity storage device 100.

FIG. 2 is a schematic view of an II-II line cross section of FIG. 1.

FIG. 3 is a schematic view of an III-III line cross section of FIG. 1.

FIG. 4 is a schematic view of IV-IV line cross section of FIG. 1.

FIG. 5 is an exploded view that schematically shows a configuration of an electrode assembly 20.

FIG. 6 is a perspective view that schematically shows the electrode assembly 20 on which a first current collector member 52 and a third current collector member 62 are attached.

FIG. 7 is a perspective view that schematically shows the electrode assembly 20 attached to a sealing body 14.

FIG. 8 is a schematic view that shows an electricity storage device 100A being a modified example and that corresponds to FIG. 2.

### DETAILED DESCRIPTION

Below, while referring to drawings, some of preferred embodiments for a herein disclosed technique will be explained. The matters being other than matters particularly mentioned in this description and being required for implementing the present disclosure (for example, a general configuration and manufacture process of an electricity storage device which do not characterize the present disclosure) can be grasped as design matters of those skilled in the art based on the related art in the present field. The present disclosure can be executed based on the contents disclosed in the present description, and the technical common sense in the present field. In addition, the below described explanation is not intended to restrict the herein disclosed technique to the below described embodiment. A wording “A to B (here, A and B are arbitrary values)” representing a range in the present description not only means “equal to or more than A and not more than B” but also semantically covers meanings “more than A and less than B”, “more than A and not more than B”, and “equal to or more than A and less than B”.

In the present description, the wording “electricity storage device” means a device that can perform electrically charging and electrically discharging. The electricity storage device semantically covers a battery, such as secondary battery (a nonaqueous electrolyte secondary battery, such as lithium ion secondary battery), and a capacitor (a physical battery), such as electric double layer capacitor. Below, the present technique would be described in detail, while an electricity storage device 100 being the lithium ion secondary battery is used as an example.

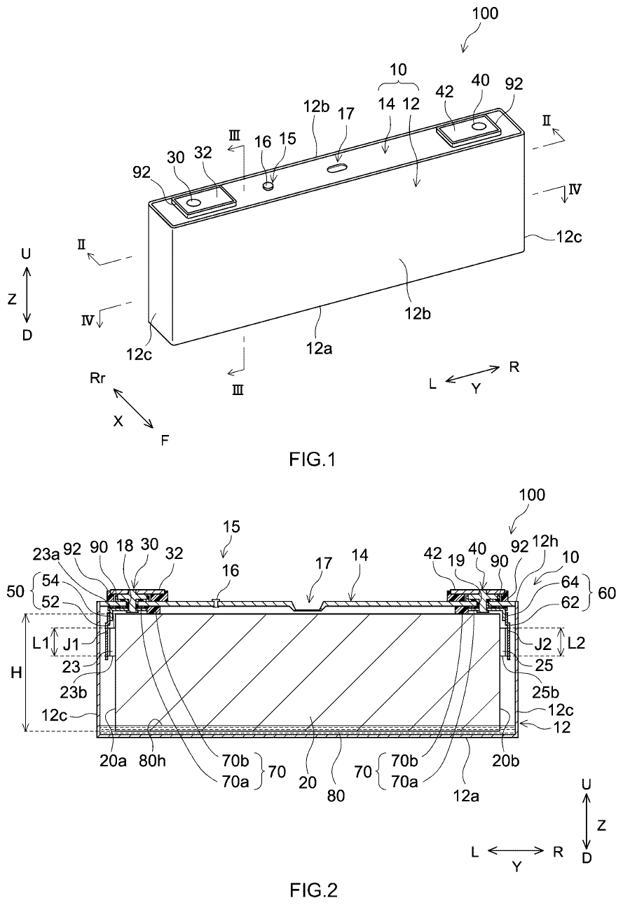

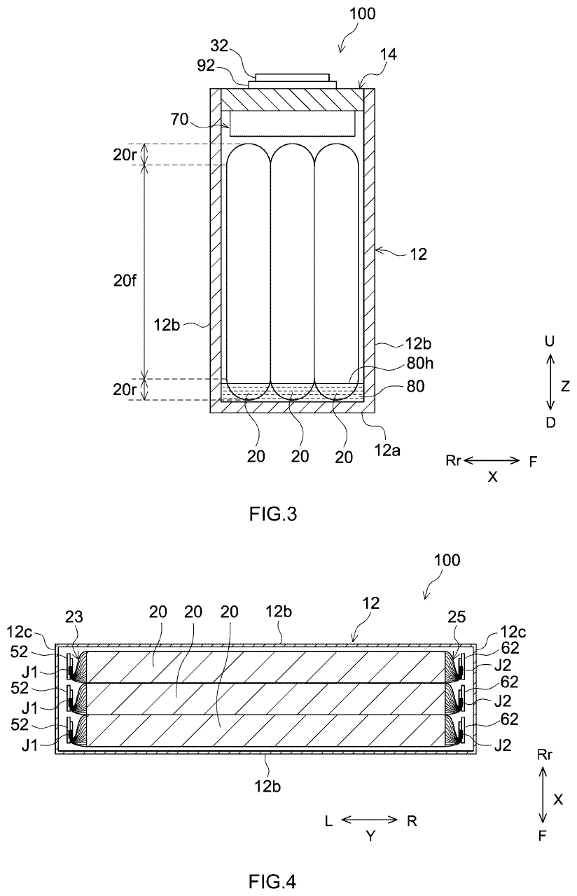

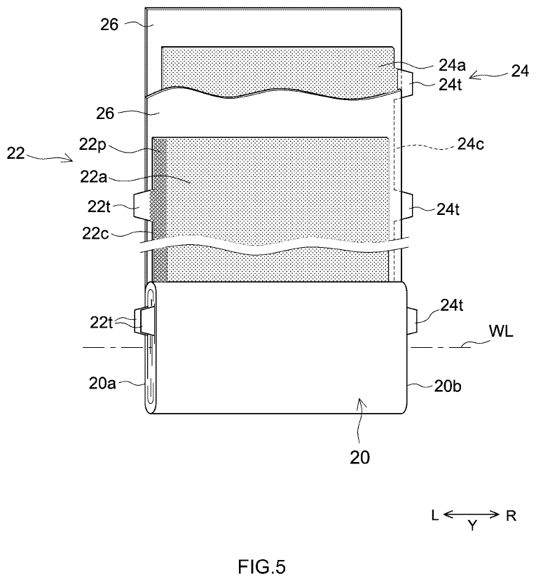

FIG. 1 is a perspective view of the electricity storage device 100. FIG. 2 is a schematic view of an II-II line cross section of FIG. 1. FIG. 3 is a schematic view of an III-III line cross section of FIG. 1. FIG. 4 is a schematic view of an IV-IV line cross section of FIG. 1. In an explanation described below, reference signs L, R, F, Rr, U, and D of drawings respectively represent left, right, front, rear, up, and down, reference signs X, Y, and Z of drawings respectively represent a thickness direction of the electricity storage device 100, a width direction orthogonal to the thickness direction, and a height direction orthogonal to the thickness direction and the width direction. However, these are merely directions for convenience sake of explanation, and are to never restrict the disposed form of the electricity storage device 100. Each drawing is schematically illustrated, and a dimensional relation (a height, a width, a thickness, or the like) does not always reflect an actual dimensional relation. Additionally, in drawings described below, the same numerals and signs are given to the members/parts providing the same effect, and overlapped explanations may be omitted or simplified.

As shown in FIGS. 1 and 2, the electricity storage device 100 includes a case 10, an electrode assembly 20, and an electrolytic solution. In the present embodiment, the electricity storage device 100 further includes a first electrode terminal 30, a first electrode outside conductive member 32, a second electrode terminal 40, a second electrode outside conductive member 42, a second electrode current collector part 60, an inside insulating member 70, a gasket 90, and an outside insulating member 92. The electrolytic solution is present, inside the case 10, mainly at an inside of the electrode assembly 20, and between the electrode assembly 20 and the case 10. In the present description, the electrolytic solution being present between the electrode assembly 20 and the case 10 is referred to as an excess electrolytic solution 80.

The case 10 is a housing that is configured to accommodate the electrode assembly 20. The case 10 has an outer appearance that is formed in a flat and bottomed rectangular parallelepiped shape (a square shape). A material of the case 10 may be the same as a material conventionally used, and is not particularly restricted. It is preferable that the case 10 is made of a metal having a predetermined strength. As one example of this kind of metal material, it is possible to use aluminum, aluminum alloy, iron, iron alloy, or the like.

The case 10 includes a bottom wall 12a, a pair of first side walls 12b, a pair of second side walls 12c, and an upper wall 14. In the present embodiment, the case 10 includes a case main body 12 including the bottom wall 12a, the pair of first side walls 12b, and the pair of second side walls 12c, includes a sealing body (below, which is also referred to as “sealing body 14”) as the upper wall 14, and includes a gas exhausting valve 17.

The case main body 12 is a container formed in a flat square shape (a hexahedron shape) whose one surface is an opening 12h. The bottom wall 12a is formed in an approximately rectangular shape that has long sides extending in a width direction Y and has short sides extending in a thickness direction X. The pair of first side walls 12b are opposed to each other in the thickness direction X, and are extending toward an upward direction U from the short sides being edges of the bottom wall 12a. The pair of second side walls 12c are opposed to each other in the width direction Y, and are extending toward the upward direction U from the long sides being edges of the bottom wall 12a. Here, an area size of the second side wall 12c is smaller than an area size of the first side wall 12b. The opening 12h is formed on an upper surface of the case main body 12 which is surrounded by the pair of first side walls 12b and the pair of second side walls 12c.

The sealing body 14 is attached to the case main body 12 so as to seal an opening 12h of the case main body 12. The sealing body 14 is a plate member having an approximately rectangular shape in a plane view. The sealing body 14 is opposed to a bottom wall 12a of the case main body 12 in the height direction Z.

The case 10 is formed by joining (for example, welding and joining) the sealing body 14 to a circumferential edge of the opening 12h of the case main body 12. The joint of the sealing body 14 can be performed, for example, by welding, such as laser welding.

In some embodiments, the sealing body 14 may be arranged not as the upper wall 14 of the case 10, but as the bottom wall 12a, the first side wall 12b, or the second side wall 12c.

As shown in FIG. 1 and FIG. 2, the gas exhausting valve 17 is provided on the sealing body 14. The gas exhausting valve 17 is configured to open when a pressure inside the case 10 becomes equal to or more than a predetermined value, so as to exhaust the gas inside the case 10.

The sealing body 14 is provided with not only the gas exhausting valve 17, but also a liquid injection hole 15 and two terminal insertion holes 18, 19. The liquid injection hole 15 is configured to communicate with an internal space of the case 10 and is a penetration hole provided for injecting an electrolytic solution at a manufacturing step of the electricity storage device 100. The liquid injection hole 15 is sealed by a sealing member 16. As the sealing member 16 described above, it is suitable to use, for example, a blind rivet. This allows the sealing member 16 to be firmly fixed inside of the case 10.

Incidentally, the liquid injection hole 15, the gas exhausting valve 17, and the terminal insertion holes 18, 19 are provided on the sealing body 14 in the present embodiment, but positions of them are not particularly restricted. In some embodiments, these may be provided on the case main body 12 or may be omitted.

As shown in FIG. 3, in the present embodiment, plural electrode assemblies 20 (three electrode assemblies in the embodiment) are accommodated at the inside of the case 10. Incidentally, a number of the electrode assemblies 20 accommodated at the inside of one case 10 is not particularly restricted, and thus may be 1, 2 or more.

The plural electrode assemblies 20 are respectively connected in parallel. However, plural electrode assemblies 20 may be connected in series.

The electrode assembly 20 may be accommodated at the inside of the case main body 12 of the case 10 in a state of being covered by a resin sheet. The resin sheet may be, for example, formed in a bag shape or a box shape, or may be formed in the box shape by folding one or plural sheets. The resin sheet may be, for example, a polyamide resin, a polyolefin resin (for example, polypropylene, or polyethylene), or the like. The resin sheet may inhibit the electrode assembly 20 and the case 10 from being electrically connected to each other.

FIG. 5 is an exploded view that schematically shows a configuration of the electrode assembly 20. As shown in FIG. 5, the electrode assembly 20 includes a first electrode 22 and a second electrode 24. The electrode assembly 20 includes a separator 26 that is configured to establish an insulation between the first electrode 22 and the second electrode 24. The electrode assembly 20 herein is a wound electrode assembly, in which the strip-shaped first electrode 22 and the strip-shaped second electrode 24 are laminated via two strip-shaped separators 26 and then wound therein while a winding axis WL is treated as a center. Longitudinal directions of the first electrode 22, the second electrode 24, and the separator 26 are aligned, and thus the winding axis WL is consistent with a shorter direction being orthogonal to the longitudinal direction. However, a structure of the electrode assembly is not to restrict the herein disclosed technique. For example, the electrode assembly may be a laminate electrode assembly, in which plural square-shaped (typically, rectangular) first electrodes and plural square-shaped (typically, rectangular) second electrodes are stacked under a state of being insulated.

Regarding the first electrode 22 and the second electrode 24, one of them is a positive electrode and the other one of them is a negative electrode. In the present embodiment, the first electrode 22 is the positive electrode and the second electrode 24 is the negative electrode.

In the present embodiment, the electrode assembly 20 is formed in a flat shape. As shown in FIG. 3, the electrode assembly 20 includes a pair of bent parts (R parts) 20r and a flat part 20f configured to couple the pair of bent parts 20r. Additionally, as shown in FIG. 2, the electrode assembly 20 includes a first end face 20a at one of ends in the winding axis WL direction and includes a second end face 20b at the other one of the ends. The electrode assembly 20 is arranged at the inside of the case 10 in a direction where the winding axis WL is approximately parallel to the width direction Y of the case 10. In other words, regarding the present embodiment, the direction of the winding axis WL of the electrode assembly 20 accommodated in the electricity storage device 100 can be rephrased as the width direction Y. The first end face 20a and second end face 20b of the electrode assembly 20 are arranged to be opposed to the pair of second side walls 12c. The pair of bent parts 20r is respectively formed at a top end and lower end of the electrode assembly 20 in the height direction Z. The pair of bent parts 20r are respectively arranged to be opposed to the upper wall (the sealing body) 14 and bottom wall 12a of the case 10. The flat part 20f is arranged to be opposed to the first side wall 12b.

Incidentally, the first end face 20a and the second end face 20b are surfaces on which edge parts of the first electrode 22 and second electrode 24 are arranged. Regarding the electrode assembly 20 that is the wound electrode assembly, each of the first end face 20a and the second end face 20b is a surface that vertically crosses the winding axis WL.

As shown in FIG. 2, the electrode assembly 20 is formed in a wide width shape extending in the width direction Y more than the height direction Z. A length of the electrode assembly 20 in the width direction is, for example, equal to or more than two times, equal to or more than 2.5 times, or equal to or more than 3 times as long as the length in the height direction. In addition, the length of the electrode assembly 20 in the width direction Y is not particularly restricted, but it can be, for example, equal to or less than 10 times, or equal to or less than 5 times as long. Regarding the electricity storage device 100, it is possible, by including the electrode assembly 20 formed in the wide width shape, to increase a capacity. On the other hand, the excess electrolytic solution 80 further hardly comes to the inside of the electrode assembly 20 as it is formed in the wider width shape, and thus there is a trade-off relationship that a salt concentration unevenness tends to be easily caused at the inside of the electrode assembly 20. The present technique can inhibit the temperature rise of the excess electrolytic solution 80 so as to suppress the heat expansion of the electrolytic solution, and thus it is possible, even on the electrode assembly 20 formed in the wide width shape, to make the excess electrolytic solution 80 easily come into the electrode assembly 20.

Incidentally, in the present description, the length of the electrode assembly 20 in the width direction Y means the length from the first end face 20a to the second end face 20b. In further particular, the length of the electrode assembly 20 in the width direction Y means a length of the separator 26 in the width direction (regarding the wound electrode assembly, a length of the strip-shaped separator 26 in the shorter direction) which is a length including neither a first electrode tab group 23 nor a second electrode tab group 25. In addition, the length of the electrode assembly 20 in the height direction means a distance from a top end to a lower end of the electrode assembly 20, which is herein a length between apices of the pair of bent parts 20r when the electrode assembly 20 is seen from the width direction Y (see FIG. 3).

The first electrode 22 (the positive electrode) includes, as shown in FIG. 5, a first electrode current collector 22c, a first electrode active material layer 22a that is fixed on at least one surface of the first electrode current collector 22c, and the first electrode protective layer 22p. However, the first electrode protective layer 22p is not essential, and can be omitted in some embodiments. The first electrode current collector 22c is formed in a strip-like shape. The first electrode current collector 22c, for example, consists of an electrically conductive metal, such as aluminum, aluminum alloy, nickel, and stainless steel. The first electrode current collector 22c herein is a metal foil, in particular, an aluminum foil.

The first electrode active material layer 22a is provided in a strip-like shape along a longitudinal direction of the strip shaped first electrode current collector 22c. The first electrode active material layer 22a contains an active material (for example, a lithium transition metal complex oxide, such as lithium nickel cobalt manganese composite oxide) that can reversibly store and release a charge carrier. The first electrode active material layer 22a may contain an arbitrary component other than the active material, for example, may contain an electrically conducting material, a binder, various additive components, or the like. As the electrically conducting material, for example, it is possible to use a carbon material, such as acetylene black (AB). As the binder, for example, it is possible to use polyvinylidene fluoride (PVdF), or the like.

The first electrode protective layer 22p is provided, as shown by FIG. 5, at a boundary portion between the first electrode current collector 22c and the first electrode active material layer 22a in the width direction Y. The first electrode protective layer 22p herein is provided at one of end parts (a left end part in FIG. 5) of the first electrode current collector 22c in an axial direction of the winding axis WL. The first electrode protective layer 22p is provided in a strip-like shape along the first electrode active material layer 22a. The first electrode protective layer 22p contains an inorganic filler (for example, an alumina). The first electrode protective layer 22p may contain an arbitrary component other than the inorganic filler, for example, may contain the electrically conducting material, the binder, the various additive components, or the like. The electrically conducting material and the binder may be the same as ones that are illustrated to be contained in the first electrode active material layer 22a.

At one of edge parts (at the first end face 20a side of the electrode assembly 20) of the first electrode current collector 22c in the axial direction of the winding axis WL, plural first electrode tabs 22t are provided. The plural first electrode tabs 22t are provided at intervals (intermittently) along a longitudinal direction of the strip shaped first electrode 22. The plural first electrode tabs 22t are configured to protrude from an edge of the first electrode current collector 22c toward the winding axis WL direction, and to protrude to an outer side more than the separator 26. The first electrode tab 22t is a part of the first electrode current collector 22c, and consists of a metal foil (an aluminum foil). However, the first electrode tab 22t may be a member being different from the first electrode current collector 22c. At least a part of the first electrode tab 22t is provided with a first electrode current collector exposed area on which neither the first electrode active material layer 22a nor the first electrode protective layer 22p is formed and on which the first electrode current collector 22c is exposed. The first electrode current collector exposed area is electrically connected via a first joining part J1 to a first electrode current collector part 50.

A shape of the first electrode tab 22t is not particularly restricted, and may be, for example, formed in a rectangular shape, a trapezoidal shape, a triangular shape, a semicircular shape, or the like.

The plural first electrode tabs 22t are laminated at one of end parts (at a left end part in FIG. 5) in the axial direction of the winding axis WL, so as to configure the first electrode tab group 23. As shown in FIG. 2 and FIG. 3, the first electrode tab group 23 is arranged at one side (at a left side in FIG. 2) of the second side wall 12c of the case main body 12. The first electrode tab group 23 is configured to protrude from the first end face 20a toward the second side wall 12c being opposed to the first end face 20a. Each of the plural first electrode tabs 22t configuring the first electrode tab group 23 is joined to the first electrode current collector part 50 (in particular, the first current collector member 52) in a state of being bent. By doing this, it is possible to enlarge a size of a body of the electrode assembly 20 accommodated at the inside of the case 10, and therefore, it is possible to make the electricity storage device 100 have the higher energy density. Incidentally, in some embodiments, each of the plural first electrode tabs 22t may be neither folded nor bent.

Based on a study of the present inventor, it was found that portions, on which the heat was easily generated at the electrical charge and discharge time of the electricity storage device 100, were the first electrode tab group 23 and the second electrode tab group 25 of the electrode assembly 20. Particularly, on the positive electrode more than the negative electrode, the heat is easily generated at the electrical charge and discharge time. Therefore, it is especially effective to suppress the heat expansion of the electrolytic solution caused by the heat generated on the first electrode tab group 23 being the positive electrode tab.

As shown in FIG. 2, a length L1 of the first electrode tab group 23 in the height direction Z may be preferably equal to or more than ⅕ H or may be equal to or more than ¼ H, when a length of the first end face 20a of the electrode assembly 20 in the height direction Z is treated as H. A resistance becomes smaller as the length L1 of the first electrode tab group 23 in the height direction Z is longer, and thus it is possible to suppress an heat generation amount of the first electrode tab group 23. On the other hand, if the length L1 of the first electrode tab group 23 in the height direction Z is too long, a distance between the excess electrolytic solution 80 and the first electrode tab group 23 becomes shorter and thus the heat of the first electrode tab group 23 happens to be more easily transmitted to the excess electrolytic solution 80. Therefore, it is good that the length L1 of the first electrode tab group 23 in the height direction Z is, for example, less than ½ H or not more than ⅓ H. Incidentally, in the present description, the length L1 of the first electrode tab group 23 in the height direction Z represents a length of the electrode assembly 20 at a boundary portion (a base part) with respect to the first end face 20a. In addition, the length H of the first end face 20a of the electrode assembly 20 in the height direction is a distance from the top end to the lower end of the first end face 20a of the electrode assembly 20, and is consistent with the length of the electrode assembly 20 in the height direction Z, regarding the present embodiment.

A lower end 23b of the first electrode tab group 23 may be arranged at a side above the half of the electrode assembly 20 in the height direction Z (at an upper wall 14 side of the case 10), or it is preferably arranged within a range being an upper part ⅖ of the height of the electrode assembly 20. Accordingly, the first electrode tab group 23 and the excess electrolytic solution 80 are spaced away from each other, and thus it is possible to suppress the temperature of the excess electrolytic solution 80 from being increased due to the heat of the first electrode tab group 23. Incidentally, in the present description, the lower end 23b of the first electrode tab group 23 is a portion being closest to a liquid surface 80h of the excess electrolytic solution 80 under a normal use state.

A distance between a top end 23a of the first electrode tab group 23 and a top end of the first end face 20a of the electrode assembly 20 may be, for example, equal to or less than ¼ H, or it may be preferably equal to or less than ⅕ H. Accordingly, it becomes further difficult to make the heat generated at the first electrode tab group 23 be transmitted to the excess electrolytic solution 80. Incidentally, the top end 23a of the first electrode tab group 23 means a portion being closest to the upper wall 14 of the case 10 (the sealing body 14 in the present embodiment).

The second electrode 24 (here, the negative electrode) includes, as shown in FIG. 5, a second electrode current collector 24c and a second electrode active material layer 24a that is fixed on at least one surface of the second electrode current collector 24c. The second electrode current collector 24c is formed in a strip like shape. The second electrode current collector 24c consists of, for example, an electrically conductive metal, such as copper, copper alloy, nickel, and stainless steel. The second electrode current collector 24c is a metal foil, in particular, a copper foil in the present embodiment.

The second electrode active material layer 24a is, as shown in FIG. 5, provided in a strip-like shape along the longitudinal direction of the strip shaped second electrode current collector 24c. The second electrode active material layer 24a contains an active material (for example, a carbon material, such as graphite) that can reversibly store and release a charge carrier. The second electrode active material layer 24a may contain an arbitrary component other than the active material, for example, a binder, a dispersing agent, various additive components, or the like. As the binder, for example, rubbers, such as styrene butadiene rubber (SBR), can be used. As the dispersing agent, for example, celluloses, such as carboxymethyl cellulose (CMC), can be used.

At one of edge parts (at the second end face 20b side of the electrode assembly 20) of the second electrode current collector 24c in the axial direction of the winding axis WL, the plural second electrode tabs 24t are provided. The second electrode tab 24t is provided an opposite side of the first electrode tabs 22t in the axial direction of the winding axis WL. The plural second electrode tabs 24t are provided at intervals (intermittently) along the longitudinal direction of the strip shaped second electrode 24. The second electrode tab 24t is configured to protrude from the edge of the second electrode current collector 24c toward the winding axis WL direction, and protrude to the outer side more than the separator 26. The second electrode tab 24t is a part of the second electrode current collector 24c and consists of a metal foil (a copper foil). However, the second electrode tab 24t may be a member different from the second electrode current collector 24c. At least a part of the second electrode tab 24t is provided with a second electrode current collector exposed area on which the second electrode active material layer 24a is not formed so that the second electrode current collector 24c is exposed. The second electrode current collector exposed area is electrically connected, via a second joining part J2, to the second electrode current collector part 60.

A shape of the second electrode tab 24t is not particularly restricted, and thus it may be formed in, for example, a rectangular shape, a trapezoidal shape, a triangular shape, a semicircular shape, or the like.

The plural second electrode tabs 24t are laminated at one of end parts (at the right end part of FIG. 5) in the axial direction of the winding axis WL, so as to configure the second electrode tab group 25. As shown in FIG. 2 and FIG. 3, the second electrode tab group 25 is arranged at the other side (at the right side in FIG. 2) of the second side wall 12c of the case main body 12. The second electrode tab group 25 is configured to protrude from the second end face 20b toward the second side wall 12c being opposed to the second end face 20b. Each of the plural second electrode tabs 24t configuring the second electrode tab group 25 is joined to the second electrode current collector part 60 (in particular, a third current collector member 62) under a state of being bent. By doing this, it is possible to enlarge the size of the body of the electrode assembly 20 accommodated at the inside of the case 10, and therefore, it is possible to make the electricity storage device 100 have the higher energy density. Incidentally, in some embodiments, each of the plural second electrode tabs 24t may be neither folded nor bent.

With respect to the height direction Z of the electricity storage device 100, a lower end 25b of the second electrode tab group 25 is positioned at a height the same as the lower end 23b of the first electrode tab group 23, or at an upper side (at the upper wall 14 side) more than the lower end 23b of the first electrode tab group 23. In other words, the lower end 23b of the first electrode tab group 23 may be positioned at a lower side (at the bottom wall 12a side) more than the lower end 25b of the second electrode tab group 25. In the present embodiment, the first electrode tab group 23 and the second electrode tab group 25 are provided at the same height (at symmetrical positions).

A range of a length L2 of the second electrode tab group 25 in the height direction Z can conform to the above described length L1 of the first electrode tab group 23 in the height direction Z. In addition, a position of the lower end 25b of the second electrode tab group 25 can conform to the above described position of the lower end 23b of the first electrode tab group 23.

The separator 26 is a member, as shown in FIG. 5, which is configured to establish an insulation between the first electrode 22 and the second electrode 24. As the separator 26, it is suitable, for example, to use a porous sheet made of a resin consisting of polyolefin resin, such as polyethylene (PE) and polypropylene (PP). The separator 26 may include a base material part that consists of the porous sheet made of the resin and include a heat resistance layer (HRL) that is provided on at least one surface of the base material part and that contains an inorganic filler. As the inorganic filler, for example, it is possible to use alumina, boehmite, aluminum hydroxide, titania, or the like.

The first electrode current collector part 50 is a portion electrically connected to the first electrode 22 of the electrode assembly 20. In the present embodiment, the first electrode current collector part 50 includes the first current collector member 52 and a second current collector member 54. The first current collector member 52 and the second current collector member 54 have electrically conductive properties, and are, for example, made of a metal. The first current collector member 52 and the second current collector member 54 are preferably made of a metal species being the same as the first electrode current collector 22c, and thus can be made of, for example, aluminum, aluminum alloy, or the like.

The first current collector member 52 is a member joined to the first electrode tab group 23. In the present embodiment, the first current collector member 52 is configured to form an electrical conduction path of the first electrode tab group 23 and the second current collector member 54. As shown in FIG. 2, the first current collector member 52 herein is a plate-shaped member. In the present embodiment, the first current collector member 52 is configured to extend along an inner side surface of the second side wall 12c of the case 10 (in the height direction Z). A lower part of the first current collector member 52 is joined to the first electrode tab group 23 via the first joining part J1. The first joining part J1 can be, for example, an ultrasonic joining part, a resistance welding part, a laser welding part, or the like. An upper part of the first current collector member 52 is connected to the second current collector member 54. A connecting method for the first current collector member 52 and the second current collector member 54 is not particularly restricted, but they are connected, for example, via the ultrasonic joining part, the resistance welding part, the laser welding part, or the like.

The first joining part J1 may be provided at an upper side above half of the first electrode tab group 23 in the height direction Z (at the upper wall 14 side of the case 10), or it is preferably good to be provided within an upper part ⅓ range of the first electrode tab group 23. The first joining part J1 is a portion where the electrical current is easily concentrated at the electrical charge and discharge time and where the heat is easily generated in particular. Thus, as the first joining part J1 is disposed to be farther from the excess electrolytic solution 80, it is possible to further suppress the heat expansion of the electrolytic solution. Incidentally, in the present description, a position of the first joining part J1 means a center of a portion connecting the top end and the lower end of the first joining part J1 in the height direction Z.

The second current collector member 54 herein is a plate-shaped member. The second current collector member 54 includes a first area extending along an inner side surface of the sealing body 14 and a second area extending along an inner side surface of the second side wall 12c of the case 10. The first area is connected to the first electrode terminal 30. The second area is connected to the first current collector member 52.

The first electrode terminal 30 is inserted into a terminal insertion hole 18 that is formed at one of end parts (at the left end part in FIG. 2) of the sealing body 14 in the width direction Y. The first electrode terminal 30 is connected to the second current collector member 54 by the lower end part being caulked at the inside of the case 10 by the second current collector member 54. The first electrode terminal 30 is preferably made of a metal, or further preferably made of, for example, aluminum or aluminum alloy. At least a part of the first electrode terminal 30 is exposed to an outer side surface of the case 10. The first electrode terminal 30 is electrically connected to the plate-shaped first electrode outside conductive member 32 at the outside of the case 10. The first electrode outside conductive member 32 is a member on which an outside member, such as bus bar, is attached. In some embodiments, the first electrode outside conductive member 32 may be omitted. Additionally, in some embodiments, the first electrode terminal 30 may be arranged on the first side wall 12b, the second side wall 12c, or the bottom wall 12a.

The first electrode terminal 30 is insulated from the sealing body 14 by the inside insulating member 70 and the gasket 90. Incidentally, the inside insulating member 70 includes a base part 70a that is disposed between the second current collector member 54 and the sealing body 14, and includes a protruding part 70b that is configured to protrude from the base part 70a toward the electrode assembly 20 side. By the protruding part 70b, a movement of the electrode assembly 20 is regulated, and thus it is possible to inhibit the sealing body 14 and the electrode assembly 20 from coming into contact with each other. Between the first electrode outside conductive member 32 and an outer side surface of the sealing body 14, the outside insulating member 92 is arranged. By the outside insulating member 92, the first electrode outside conductive member 32 and the sealing body 14 are insulated. Incidentally, neither the first electrode outside conductive member 32 nor the outside insulating member 92 are essential configurations, and they can be suitably omitted. The inside insulating member 70, the gasket 90, and the outside insulating member 92 can be made of, for example, a fluorine-base resin, such as perfluoroalkoxy alkane (PFA) and polytetra fluoroethylene (PTFE), or a synthetic resin material, such as polyphenylene sulfide (PPS).

As shown in FIG. 2, the second electrode tab group 25 is electrically connected to the second electrode terminal 40 via the second electrode current collector part 60. The second electrode current collector part 60 includes a third current collector member 62 and a fourth current collector member 64. The third current collector member 62 and the fourth current collector member 64 are preferably made of a metal species being the same as the second electrode current collector 24c, and can be made of, for example, an electrically conductive metal, such as copper and copper alloy.

The third current collector member 62 is a member joined to the second electrode tab group 25. In the present embodiment, the third current collector member 62 is configured to form an electrical conduction path of the second electrode tab group 25 and the fourth current collector member 64. A lower part of the third current collector member 62 is joined to the second electrode tab group 25 via the second joining part J2. The second joining part J2 can be, for example, the ultrasonic joining part, the resistance welding part, the laser welding part, or the like. Incidentally, the other configurations of the third current collector member 62 can be configured while conforming to a configuration of the above described first current collector member 52. Similarly, the configuration of the fourth current collector member 64 can be configured while conforming to a configuration of the above described second current collector member 54.

The second electrode terminal 40, which is inserted into the terminal insertion hole 19 formed at one of end parts (at the right end part in FIG. 2) of the sealing body 14 in the width direction Y, is connected to the fourth current collector member 64 by the lower end part being caulked by the fourth current collector member 64 at the inside of the case 10. The second electrode terminal 40 is preferably made of a metal, or further preferably made of, for example, copper or copper alloy. At least a part of the second electrode terminal 40 is exposed to the outer side surface of the case 10. The second electrode terminal 40 is electrically connected to the plate-shaped second electrode outside conductive member 42 at the outside of the case 10. The second electrode outside conductive member 42 is a member on which the outside member, such as bus bar, is attached. In some embodiments, the second electrode outside conductive member 42 may be omitted. Additionally, in some embodiments, the second electrode terminal 40 may be arranged on the first side wall 12b, the second side wall 12c, or the bottom wall 12a.

The second electrode terminal 40 is insulated from the sealing body 14 by the inside insulating member 70 and the gasket 90. Incidentally, a detail of the inside insulating member 70 is similar to the contents explained for the above described first electrode terminal 30 side, and thus an explanation of it is omitted. Between the second electrode outside conductive member 42 and the outer side surface of the sealing body 14, the outside insulating member 92 is arranged. By the outside insulating member 92, the second electrode outside conductive member 42 and the sealing body 14 are insulated. Incidentally, neither the second electrode outside conductive member 42 nor the outside insulating member 92 are essential configurations, and they can be suitably omitted.

The electrolytic solution is, for example, a nonaqueous electrolytic solution containing an organic solvent and a supporting salt. As the organic solvent, it is possible to use an aprotic solvent, such as carbonates, esters, and ethers. Among them, it is possible to suitably use carbonates, for example, ethylene carbonate (EC), diethyl carbonate (DEC), dimethyl carbonate (DMC), ethyl methyl carbonate (EMC), or the like. Alternatively, it is possible to preferably use a fluorine base solvent, such as fluorinated carbonate, like monofluoroethylene carbonate (MFEC), difluoroethylene carbonate (DFEC), monofluoromethyl difluoromethyl carbonate (F-DMC), or trifluoro dimethyl carbonate (TFDMC). Regarding the organic solvent as described above, one kind could be used alone, alternatively two or more kinds could be suitably combined so as to be used. As the supporting salt, it is possible to suitably use, for example, the lithium salt, such as LiPF₆, LiBF₄, LiClO₄, or the like. Although a concentration of the supporting salt is not particularly restricted, it is preferable to be, for example, equal to or more than 0.7 mol/L and not more than 1.3 mol/L.

The electrolytic solution may, insofar as an effect of the present technique is not significantly spoiled, contain a component other than the above described organic solvent and supporting salt, and can contain, for example, various additive agents, such as gas generating agent, coating layer forming agent, dispersing agent, and thickening agent.

The electricity storage device 100 is, normally, used while the bottom wall 12a of the case 10 is arranged toward a vertically downward direction. In the present description, an use state described above is referred to as “normal use state”, too. In the normal use state, the electrolytic solution contains the excess electrolytic solution 80 that is present between the electrode assembly 20 and the case 10. The excess electrolytic solution 80 is present at the bottom wall 12a side of the case 10.

If the electricity storage device 100 is in the electrical charge state, the negative electrode (for example, the negative electrode active material) expands and thus there is a tendency that the electrolytic solution is exhausted from the inside of the electrode assembly 20. In addition, if the electricity storage device 100 is in the electrical discharge state, the negative electrode (for example, the negative electrode active material) contracts and thus there is a tendency that the excess electrolytic solution 80 enters to the inside of the electrode assembly 20. Therefore, the liquid surface 80h of the excess electrolytic solution 80 can fluctuate in accordance with a SOC (state of charge) of the electricity storage device 100. In the present description, a state in which the SOC is equal to or more than 95% and not more than 100% is referred to as “full electrical charge state”, and a state in which the SOC is equal to or more than 0% and not more than 15% (which contains SOC 0%) is referred to as “electrical discharge state”, too.

In the normal use state and further the full electrical charge state, a height of the excess electrolytic solution 80 from the bottom wall 12a of the case 10 to the liquid surface 80h can be, for example, equal to or less than 1/10 H, equal to or less than 1/15 H, or equal to or less than 1/20 H (“H” represents the above described length H of the first end face 20a of the electrode assembly 20 in the height direction Z). Accordingly, it is possible to enlarge the distance between the first electrode tab group 23 and the excess electrolytic solution 80. Additionally, in the normal use state and further the full electrical charge state, it is good that the height of the excess electrolytic solution 80 from the bottom wall 12a of the case 10 to the liquid surface 80h is, for example, equal to or more than 1/100 H or equal to or more than 1/50 H. Accordingly, it is possible to inhibit the electrolytic solution entering into the electrode assembly 20 at the electrically discharging time from running out.

In the normal use state and further the full electrical charge state, it is good that a distance between the liquid surface 80h of the excess electrolytic solution 80 and the lower end 23b of the first electrode tab group 23 is, for example, equal to or more than ½ H, or it is preferable that it is equal to or more than ⅗ H. By doing this, it is possible to make the heat generated on the first electrode tab group 23 at the electrically discharging time from being transmitted to the excess electrolytic solution 80.

In the normal use state and further the electrical discharge state, it is good that the distance between the liquid surface 80h of the excess electrolytic solution 80 and the lower end 23b of the first electrode tab group 23 is, for example, equal to or more than ½ H, it is preferable that it is equal to or more than ⅗ H, or it is further preferable that it is equal to or more than ⅔ H. Accordingly, the heat generated on the first electrode tab group 23 at the electrically charging time becomes hardly transmitted to the excess electrolytic solution 80.

Incidentally, in the present description, a height of the liquid surface 80h of the excess electrolytic solution 80 is a height from the inner side surface of the bottom wall 12a at the time when a surface temperature of the electricity storage device 100 is 40° C. Incidentally, the height of the liquid surface 80h of the excess electrolytic solution 80 can be measured, for example, by an image analysis measured with computed tomography (CT), a sensor disposed at the inside of the case 10, or the like. In addition, the surface temperature of the electricity storage device 100 means a temperature at a central part of a side surface whose area size is the largest (here, the first side wall 12b) of the side walls of the electricity storage device 100. The surface temperature of the electricity storage device 100 can be, for example, measured with a thermocouple.

A positional relationship of the second electrode tab group 25 and the excess electrolytic solution 80 can conform to the above described positional relationship of the first electrode tab group 23 and the excess electrolytic solution 80.

Below, although an example of a manufacturing method of the electricity storage device 100 will be described, it is not to restrict the manufacturing method of the electricity storage device 100. The manufacturing method of the electricity storage device 100 can contain, for example, a forming step for forming the electrode assembly 20, a constructing step for constructing the battery assembly, and a liquid injecting step for injecting the electrolytic solution. In addition, the herein disclosed manufacturing method may further contain another step at an arbitrary phase, an order of the steps may be suitably changed, or some steps may be suitably omitted.

The forming step may be performed in a manner similar to or identical to a well-known method. The strip shaped first electrode 22, the strip shaped second electrode 24, and 2 strip shaped separators 26 are prepared. Next, they are laminated to arrange the separator 26 between the first electrode 22 and the second electrode 24. At that time, they are laminated to align the longitudinal directions of them. Then, the electrode assembly 20 is manufactured by winding the laminate body with the winding axis WL being the center of it (see FIG. 5). At the forming step, it is possible to suitably adjust the arrangement of the first electrode tab group 23 and the second electrode tab group 25.

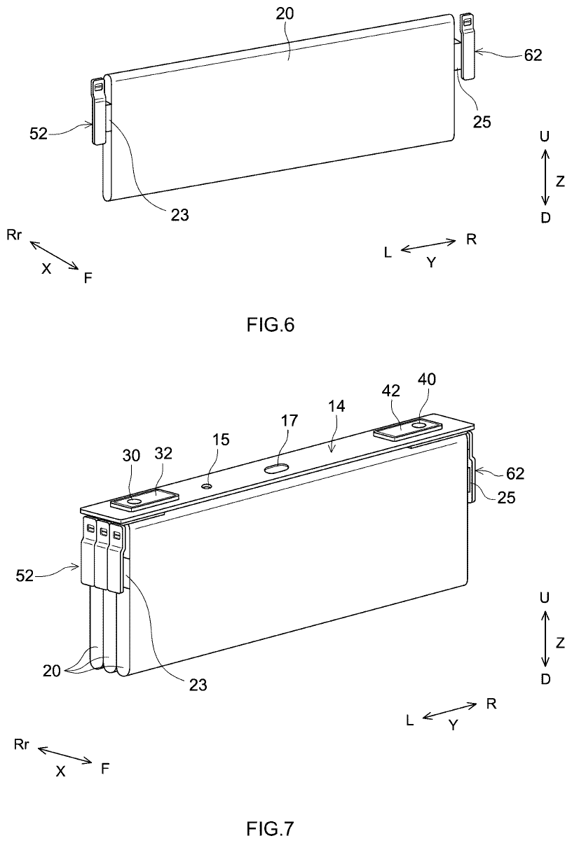

The constructing step may be performed in a manner similar to or identical to a well-known method. FIG. 6 is a perspective view that schematically shows the electrode assembly 20 on which the first current collector member 52 and the third current collector member 62 are attached. FIG. 7 is a perspective view that schematically shows the electrode assembly 20 on which the sealing body 14 is attached. Although an example of the construction is shown below, it is not to restrict a construction order, and additionally, a construction explained below can be performed before and after the other steps, too. For example, at first, the first electrode terminal 30 is attached to the terminal insertion hole 18 of the sealing body 14. At that time, the gasket 90 is arranged between the first electrode terminal 30 and the sealing body 14. Next, the second current collector member 54 and the inside insulating member 70 are arranged on the inner side surface of the sealing body 14. At that time, it should be noted that the inside insulating member 70 is arranged between the inner side surface of the sealing body 14 and the second current collector member 54. Then, by performing a caulking process (riveting) on the end part of the first electrode terminal 30 being configured to protrude toward the inner side surface side of the sealing body 14, the second current collector member 54 and the inside insulating member 70 are fixed to the sealing body 14. Regarding the second electrode terminal 40, similarly, the second electrode terminal 40 is inserted into the terminal insertion hole 19, and then the gasket 90, the fourth current collector member 64, and the inside insulating member 70 are fixed to the sealing body 14. On the outer side surface of the sealing body 14, the outside insulating member 92 is arranged at a periphery of the gasket 90 that is attached to the first electrode terminal 30. On the arranged outside insulating member 92, the first electrode outside conductive member 32 is attached, so as to make the first electrode terminal 30 and the first electrode outside conductive member 32 be electrically connected. The second electrode outside conductive member 42 can be treated similarly to the first electrode outside conductive member 32, and thus an explanation of it is omitted.

At the constructing step, the first current collector member 52 is joined to the first electrode tab group 23 of the electrode assembly 20. The third current collector member 62 is joined to the second electrode tab group 25. By doing this, as shown in FIG. 6, the electrode assembly 20 on which the first current collector member 52 and the third current collector member 62 are attached is manufactured. The joining method is not particularly restricted, and may be, for example, ultrasonic joining, resistance welding, laser welding, or the like. After that, the second current collector member 54 attached to the sealing body 14 and the first current collector member 52 attached to the electrode assembly 20 are joined. Similarly, the fourth current collector member 64 attached to the sealing body 14 and the third current collector member 62 attached to the electrode assembly 20 are joined, so that the assembly as shown in FIG. 7 is manufactured. The joining method described above is not particularly restricted, and m ay be, for example, the ultrasonic joining, the resistance welding, the laser welding, or the like.

Then, the assembly as shown in FIG. 7 is inserted to the inside of the case main body 12. At that time, it is performed to make the first electrode tab group 23 be arranged at one side of the second side wall 12c and to make the second electrode tab group 25 be arranged at the other side of the second side wall 12c. After that, by joining (for example, laser welding) the sealing body 14 to the circumferential edge of the opening 12h of the case main body 12, the case main body 12 and the sealing body 14 are attached. By doing as described above, the electricity storage device assembly is manufactured.

At the liquid injecting step, the electrolytic solution is injected from the liquid injection hole 15 to the inside of the case 10 according to a well known method. At that time, by adjusting an amount of the injected electrolytic solution, it is possible, as described above, to implement the positional relationship of the excess electrolytic solution 80 and the first electrode tab group 23. After the liquid injection, the liquid injection hole 15 is sealed by the sealing member 16.

After that, for example, under a predetermined condition, by performing an initial electrical charge, an aging process, or the like, the electricity storage device 100 in an available state is manufactured.

The electricity storage device 100 can be used for various purposes, and thus, for example, is used as a battery for a vehicle. A kind of the vehicle is not particularly restricted, but it may be, for example, a plug-in hybrid electric vehicle (PHEV), a hybrid electric vehicle (HEV), a battery electric vehicle (BEV), or the like. In addition, the electricity storage device 100 can be suitably used as a battery pack in which plural electricity storage devices 100 are arranged in a predetermined arrangement direction.

Above, some embodiments of the present disclosure are explained, but the above described embodiments are merely examples. The present disclosure can be implemented in various other forms. The present disclosure can be executed based on the contents disclosed in the present description, and the technical common sense in the present field. The technique recited in the appended claims includes variously deformed or changed versions of the embodiments that have been illustrated above. For example, one part of the above described embodiment can be replaced with another deformed aspect, and furthermore another deformed aspect can be added to the above described embodiment. In addition, unless a technical feature is explained to be essential, this technical feature can be appropriately deleted.

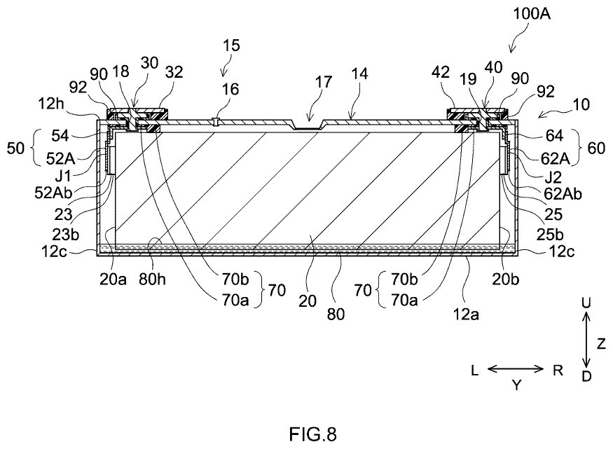

For example, in the above described embodiment, as shown by FIG. 2, a lower end of the first current collector member 52 has been positioned at a lower side than the lower end 23b of the first electrode tab group 23. However, the first current collector member 52 emits the heat at the electrically charging and discharging time, and thus it is preferable that a distance between the first current collector member 52 and the excess electrolytic solution 80 are longer. FIG. 8 is a schematic view that shows an electricity storage device 100A being a modified example and that corresponds to FIG. 2. The electricity storage device 100A includes a first current collector member 52A that is joined to the first electrode tab group 23 via the first joining part J1. A lower end 52Ab of the first current collector member 52A is positioned at an upper part (at the upper wall 14 side) than the lower end 23b of the first electrode tab group 23 in the height direction Z. Accordingly, the heat of the first current collector member 52A becomes hardly transmitted to the excess electrolytic solution 80, and thus it is possible to suppress the heat expansion of the electrolytic solution. In addition, the electricity storage device 100A includes a third current collector member 62A that is joined to the second electrode tab group 25 via the second joining part J2. In the third current collector member 62A, similarly, it is preferable that a lower end 62Ab is positioned at the upper part than the lower end 25b of the second electrode tab group 25 in the height direction Z. Incidentally, each of the lower end 52Ab of the first current collector member 52A and the lower end 62Ab of the third current collector member 62A means a portion being the closest to the liquid surface 80h of the excess electrolytic solution 80 in the normal use state.

Additionally, for example, in the above described embodiment, the first electrode current collector part 50 includes the first current collector member 52 and the second current collector member 54 so as to electrically connect the first electrode tab group 23 of the electrode assembly 20 and the first electrode terminal 30, but it is not restricted to this. For example, the first current collector member being joined to the first electrode tab group 23 of the electrode assembly 20 may be directly connected to the first electrode terminal 30. Additionally, in some embodiments, further, the first electrode terminal 30 may be omitted and the first current collector member being connected to the first electrode tab group 23, itself, may be configured as the first electrode terminal. For example, a part of the first current collector member may be joined to the first electrode tab group 23 and another part of the first current collector member may be directly connected to the outside member, such as bus bar.

While described above, as a particular aspect of the herein disclosed technique, it is possible to use a recitation of each item described below.

Item 1. An electricity storage device, comprising:
an electrode assembly comprising a first electrode and a second electrode;
an electrolytic solution;
a case accommodating the electrode assembly and the electrolytic solution; and
a first current collector member that is electrically connected to the first electrode, wherein
the case comprises:
   a bottom wall;
   a pair of side walls extending from an edge of the bottom wall and being opposed to each other in a width direction; and
   an upper wall opposed to the bottom wall in a height direction,
the electrode assembly comprises:
   a first electrode tab group comprising plural first electrode tabs protruding from a first end face at one side in the width direction; and
   a second electrode tab group comprising plural second electrode tabs protruding from a second end face at the other side in the width direction,
the first current collector member is joined to the first electrode tab group via a first joining part,
a length of the electrode assembly in the width direction is equal to or more than two times as long as a length of the electrode assembly in the height direction,
the electrolytic solution comprises an excess electrolytic solution that is present between the electrode assembly and the case,
when a length of the first end face of the electrode assembly in the height direction is treated as H, a length of the first electrode tab group in the height direction is equal to or more than ⅕ H and less than ½ H, and
in a state where the bottom wall is arranged in a vertically downward direction and a SOC (state of charge) is equal to or more than 95%,
   a height of the excess electrolytic solution from the bottom wall to a liquid surface is equal to or more than 1/100 H and not more than 1/10 H, and
   a distance between the liquid surface of the excess electrolytic solution and a lower end of the first electrode tab group is equal to or more than ½ H.
      Item 2. The electricity storage device recited in Item 1, wherein
the lower end of the first electrode tab group is arranged at an upper side above half of the electrode assembly in the height direction.
   Item 3. The electricity storage device recited in Item 1 or 2, wherein
the distance between the liquid surface of the excess electrolytic solution and the lower end of the first electrode tab group is equal to or more than ½ H in a state where the SOC is equal to or less than 15%.
   Item 4. The electricity storage device recited in any one of Items 1 to 3, wherein
a distance between a top end of the first electrode tab group and a top end of the first end face of the electrode assembly is equal to or less than ¼ H.
   Item 5. The electricity storage device recited in any one of Items 1 to 4, wherein
the first electrode is a positive electrode.
   Item 6. The electricity storage device recited in any one of Items 1 to 5, wherein
the first joining part is provided at an upper side above half of the first electrode tab group in the height direction.
   Item 7. The electricity storage device recited in any one of Items 1 to 6, wherein
a lower end of the first current collector member is arranged at an upper side than the lower end of the first electrode tab group in the height direction.

What is claimed is:

1. An electricity storage device, comprising:
an electrode assembly comprising a first electrode and a second electrode;
an electrolytic solution;
a case accommodating the electrode assembly and the electrolytic solution; and
a first current collector member that is electrically connected to the first electrode, wherein
the case comprises:
a bottom wall;
a pair of side walls extending from an edge of the bottom wall and being opposed to each other in a width direction; and
an upper wall opposed to the bottom wall in a height direction,
the electrode assembly comprises:
a first electrode tab group comprising plural first electrode tabs protruding from a first end face at one side in the width direction; and
a second electrode tab group comprising plural second electrode tabs protruding from a second end face at the other side in the width direction,
the first current collector member is joined to the first electrode tab group via a first joining part,
a length of the electrode assembly in the width direction is equal to or more than two times as long as a length of the electrode assembly in the height direction,
the electrolytic solution comprises an excess electrolytic solution that is present between the electrode assembly and the case,
when a length of the first end face of the electrode assembly in the height direction is treated as H, a length of the first electrode tab group in the height direction is equal to or more than ⅕ H and less than ½ H, and
in a state where the bottom wall is arranged in a vertically downward direction and a SOC (state of charge) is equal to or more than 95%,
a height of the excess electrolytic solution from the bottom wall to a liquid surface is equal to or more than 1/100 H and not more than 1/10 H, and
a distance between the liquid surface of the excess electrolytic solution and a lower end of the first electrode tab group is equal to or more than ½ H.

2. The electricity storage device according to claim 1, wherein
the lower end of the first electrode tab group is arranged at an upper side above half of the electrode assembly in the height direction.

3. The electricity storage device according to claim 1, wherein
the distance between the liquid surface of the excess electrolytic solution and the lower end of the first electrode tab group is equal to or more than ½ H in a state where the SOC is equal to or less than 15%.

4. The electricity storage device according to claim 1, wherein
a distance between a top end of the first electrode tab group and a top end of the first end face of the electrode assembly is equal to or less than ¼ H.

5. The electricity storage device according to claim 1, wherein
the first electrode is a positive electrode.

6. The electricity storage device according to claim 1, wherein
the first joining part is provided at an upper side above half of the first electrode tab group in the height direction.

7. The electricity storage device according to claim 1, wherein
a lower end of the first current collector member is arranged at an upper side than the lower end of the first electrode tab group in the height direction.
